(19) United States
(12) Patent Application Publication
(10) Pub. No.: US 2026/0318411 A1
(43) Pub. Date: Oct. 15, 2026

(54) PARKING LOCK DEVICE WITH A STOP ELEMENT

(71) Applicant: Schaeffler Technologies AG & Co. KG, Herzogenaurach (DE)

(72) Inventors: Markus Rost, Herzogenaurach (DE); Denise Beck, Zirndorf (DE); Waldemar Lysikov, Nürnberg (DE)

(73) Assignee: Schaeffler Technologies AG & Co. KG, Herzogenaurach (DE)

(21) Appl. No.: 19/483,978

(22) PCT Filed: Apr. 5, 2024
(86) PCT No.: PCT/DE2024/100281

§ 371 Date: Nov. 12, 2025

(30) Foreign Application Priority Data
May 15, 2023 (DE) 10 2023 112 690.3

(51) Int. Cl. F16H 63/34

(52) U.S. Cl. CPC F16H 63/3433; F16H 63/3441

(57) ABSTRACT

A parking lock device includes a first fastening element, a carrier element arranged to be fastened to a housing by the first fastening element, a locking pawl, an actuating element and a stop element. The locking pawl is pivotable on the carrier element between a locked position where the locking pawl is latched with a rotary component, and a release position in which the locking pawl is decoupled from the rotary component. The actuating element is axially displaceable between a first axial position where the actuating element deflects the locking pawl into the locked position, and a second axial position where the locking pawl is in the release position. The stop element is formed separately from the carrier element and arranged to limit axial displacement of the actuating element. The stop element can be fastened to the carrier element or the housing by a second fastening element.

### CROSS-REFERENCE TO RELATED APPLICATIONS

This application is the United States National Phase of PCT Appln. No. PCT/DE2024/100281 filed Apr. 5, 2024, which claims priority to German Application No. DE 102023112690.3 filed May 15, 2023, the entire disclosures of which are incorporated by reference herein.

### TECHNICAL FIELD

The present disclosure relates to a parking lock device.

### BACKGROUND

DE 10 2018 111 184 A1 describes a parking lock device having a locking pawl for a form-fit connection with a parking lock gear, a conical locking body for actuating the locking pawl and an actuator actuating the locking body. A support body is fastened to a transmission housing with two screws to support the locking body.

### SUMMARY

The present disclosure provides a parking lock device that is more reliable and robust. Furthermore, an unintentional loosening of the fastening of the parking lock device to the housing is prevented.

The disclosed parking lock device can increase the stability of the parking lock device if there is a stop of the actuating element. The installation of the parking lock device can be made easier and the parking lock device can be made more cost-effective.

The parking lock device can be arranged in a vehicle. The vehicle can be a motor vehicle. The vehicle can be an electric vehicle.

When in the locked position, the parking lock device can restrict or prevent a movement of the vehicle from a parked position. For example, a movement of a vehicle on a slope can be prevented. The parking lock device can be connected to the transmission. The parking lock device can be arranged in or on the transmission.

The housing can be a transmission housing of the transmission.

The rotary component can be a locking ring or a parking lock gear. The rotary component can be connected to a transmission shaft of the transmission. The rotary component can have a locking toothing, in particular arranged on an outer circumference. In the locked position, the locking pawl can latch with a form fit into the locking toothing. The locking pawl can have a pawl tooth which is form-fit connected to the locking toothing in the locked position.

The carrier element can be made of plastic and/or aluminum. This allows the carrier element to be made more cost-effectively and to have a lighter weight. The carrier element can be fastened to the housing by at least two first fastening elements.

The locking pawl, the carrier element, the actuating element, and the stop element can be constructed as a pre-assembly. The pre-assembly can be fastened to the housing with the first fastening element. The pre-assembly can be tested for compliance with a specified function before being fastened to the housing by the first fastening element.

The stop element can block an axial displacement of the actuating element beyond the second axial position and opposite the first axial position.

The first fastening element can be a screw. The fastening element of the stop element can be a screw.

The locking pawl can be pretensioned by a return spring to assume the release position.

The actuating element can be pretensioned into the first axial position by a spring element, in particular a helical spring.

In an example embodiment, the first fastening element also forms the fastening element of the stop element. The first fastening element and the second fastening element can also be separate components, which are in particular spaced apart from one another.

In an example embodiment, a stop force of the actuating element can be supported on the housing via the fastening element when it comes into contact with the stop element. This allows the stop force to be supported reliably and gently for the other components of the parking lock device. The stop force can act in an axial direction opposite a fastening direction of the first fastening element, in particular a screwing direction of the first fastening element designed as a screw.

In an example embodiment, the stop element is designed as a stop plate. The stop element can be hardened. The stop element can be a steel component. This means that a reliable stop can be implemented even when the parking lock device ratchets, where the stop dynamics are very high.

In an example embodiment, the actuating element rests against the stop element to limit the axial movement in the first axial direction. The actuating element can be hardened. The actuating element can be a steel component. The actuating element can rest against the stop element with a cylinder base.

In an example embodiment, the stop element has at least one fastening region coupled to the fastening element and a stop region implementing the movement limitation of the actuating element and spaced apart from the fastening region. The stop element can have at least two fastening regions. The stop region can be located between the fastening regions. However, a first fastening element can be assigned to each of the fastening regions. The actuating element can rest on the stop region when stopped.

In an example embodiment, the fastening region and the stop region are spaced apart from one another in the axial direction. The fastening region can be arranged to be closer to the locking pawl in the axial direction than the stop region. The fastening region and the stop region can be spaced apart from one another in a direction perpendicular to the axial direction.

In an example embodiment, the actuating element has a conical actuating region which converts an axial movement of the actuating element into a pivoting movement of the locking pawl. The locking pawl can have an outer contour against which rests the actuating region for assuming the locked position. The actuating region can be adjacent to the cylinder base, with which the actuating element rests against the stop element when it stops.

In an example embodiment, the locking pawl is received on the carrier element by a connecting element and is pivotable about the connecting element, and the connecting element has a longitudinal axis aligned to be parallel to the axial direction. The connecting element can be a bolt. The bolt can be received in an opening in the carrier element.

In an example embodiment, the actuating element is supported in the locked position on a support element which is firmly connected to the housing via the first fastening element. The support element can be hardened. The support element can be a steel component.

Further advantages and embodiments of the disclosure are apparent from the description of the figures and the drawings.

### BRIEF DESCRIPTION OF THE DRAWINGS

The present disclosure is described in detail below with reference to the drawings. In the drawings, in particular:

FIGS. 1 and 2 each show a spatial view of a parking lock device in an example embodiment.

FIG. 3 shows a spatial cross-section of the parking lock device in a release position.

FIG. 4 shows a cross-section of the parking lock device in a locked position.

FIG. 5 shows an exploded view of the parking lock device.

### DETAILED DESCRIPTION

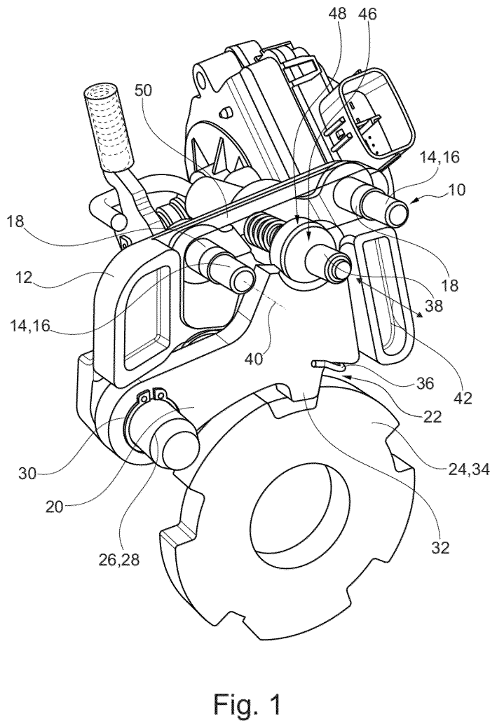

FIGS. 1 and 2 each show a spatial view of a parking lock device in an example embodiment. The parking lock device 10 shown in FIG. 1 is arranged on a transmission. The transmission includes a transmission housing (not shown here), to which the parking lock device 10 can be fastened. The parking lock device 10 includes a carrier element 12 which can be fastened to the transmission housing by means of two first fastening elements 14. The single first fastening element 14 is designed as a screw 16 which is received in a sleeve 18 in the carrier element 12.

A locking pawl 20 is received pivotably on the carrier element 12. The locking pawl 20 is pivotable between a locked position 22 shown here, in which the locking pawl 20 latches with a form fit into a rotary component 24, and a release position in which the locking pawl 20 is decoupled from the rotary component 24 and thus the rotary component 24 can be rotated in an unhindered manner by the locking pawl 20.

The locking pawl 20 is received pivotably on the carrier element 12 by a connecting element 26. The connecting element 26 is designed as a bolt 28, which is secured on both sides to the carrier element 12 by a retaining ring 30. The locking pawl 20 includes a pawl tooth 32 which, in the locked position 22, latches with a form fit into the rotary component 24, here the parking lock gear 34. The locking pawl 20 is pretensioned in the direction of the release position by a return spring 36.

An actuating element 38 is accommodated in an axial direction 42 parallel to a longitudinal axis 40 of the first fastening element 14 so as to be displaceable relative to the carrier element 12 and the locking pawl 20. The locking pawl 20 is deflected into the locked position 22 via a conical actuating region 46 on the actuating element 38 when the actuating element 38 assumes a first axial position 48 as shown here. The conical actuating region 46 thus converts an axial movement of the actuating element 38 into a pivoting movement of the locking pawl 20. In the case of a second axial position deviating from the first axial position 48, however, the actuating element 38 allows the locking pawl 20 to be deflected into the release position by the restoring force of the return spring 36.

The first fastening elements 14 also connect a support element 50, shown here as semi-transparent, on which the actuating element 38 is supported in the locked position 22, to the transmission housing.

FIG. 2 shows the parking lock device from FIG. 1 in a rear view. The actuating element 38 is axially displaceable by an actuator element 52. The actuator element 52 has a drive shaft 54 which is connected to a hook element 56 in a rotationally fixed manner. During a rotational movement, the hook element 56 engages an actuating rod 58 to which the actuating element 38 is connected in an axially displaceable manner. If the hook element 56 rotates driven by the drive shaft 54, the actuating rod 58 also moves in the axial direction 42.

A locking device 60 is arranged on the hook element 56, which secures the release position of the actuating element 38 via the actuating rod 58.

The parking lock device 10 includes a stop element 62 which is formed separately from the carrier element 12 and which limits the axial displacement of the actuating element 38 in at least a first axial direction 64 and which can be fastened to the housing via two fastening elements 66. The stop element 62 is designed as a stop plate 68.

The two first fastening elements 14 also form the fastening elements 66 of the stop element 62. The connecting element 26 has a longitudinal axis 70 aligned to be parallel to the axial direction 42.

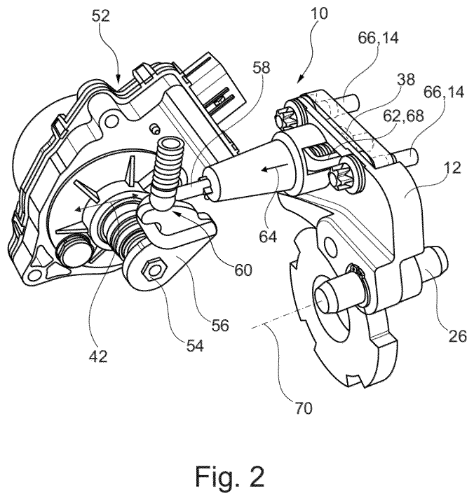

FIG. 3 shows a spatial cross-section of the parking lock device in a release position. A stop force 72 when the actuating element 38 abuts the stop element 62, for example when the actuating element 38 is axially displaced from the first axial position into the second axial position 74 shown here, which allows the release position 76 of the locking pawl 20, can be supported on the housing via the first fastening elements 14. The stop force 72 acts in an axial direction 78 opposite the screwing direction. The actuating element 38 rests against the stop element 62 when it stops to limit the axial movement in the first axial direction 64.

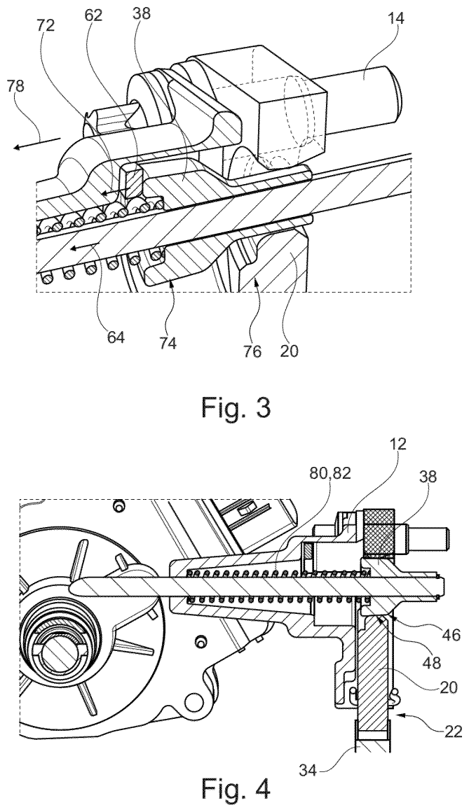

FIG. 4 shows a cross-section of the parking lock device in a locked position. The actuating element 38 is pretensioned in the first axial position 48 by a spring element 80. The locking pawl 20 is in the locked position 22. The spring element 80 is arranged between the carrier element 12 and the actuating element 38 and is designed in particular as a helical spring 82. The conical actuating region 46 presses the locking pawl 20 downwards to form a form-fit connection with the parking lock gear 34.

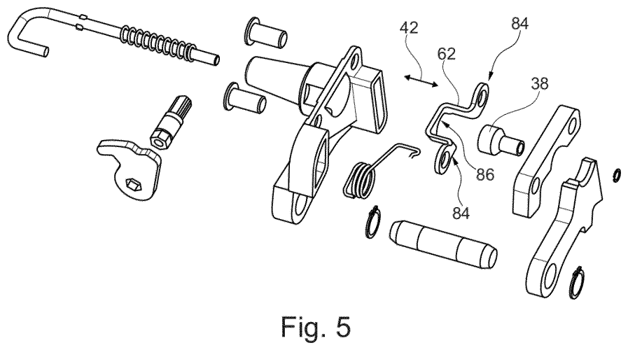

FIG. 5 shows an exploded view of the parking lock device. The stop element 62 has at least one fastening region 84 coupled to the respective fastening element and a stop region 86 which implements the movement limitation of the actuating element 38 and is spaced apart from the two fastening regions 84. The fastening regions 84 and the stop region 86 are spaced apart from one another in the axial direction 42.

### REFERENCE NUMERALS

10 Parking lock device
12 Carrier element
14 First fastening element
16 Screw
18 Sleeve
20 Locking pawl
22 Locked position
24 Rotary component
26 Connecting element
28 Bolt
30 Retaining ring
32 Pawl tooth
34 Parking lock gear
36 Return spring
38 Actuating element
40 Longitudinal axis
42 Axial direction
46 Actuating region
48 First axial position
50 Support element
52 Actuator element
54 Drive shaft
56 Hook element
58 Actuating rod
60 Locking device
62 Stop element
64 First axial direction
66 Fastening element
68 Stop plate
70 Longitudinal axis
72 Stop force
74 Second axial position
76 Release position
78 Axial direction
80 Spring element
82 Helical spring
84 Fastening region
86 Stop region

1. A parking lock device comprising:
a carrier element which can be fastened to a housing by means of at least one first fastening element having a longitudinal axis,
a locking pawl received pivotably on the carrier element which can be pivoted between a locked position, in which the locking pawl latches with a form fit into a rotary component, and a release position, in which the locking pawl is decoupled from the rotary component,
an actuating element which is displaceable in the axial direction parallel to the longitudinal axis, which in a first axial position deflects the locking pawl into the locked position, and in a second axial position allows the release position, and
a stop element, formed separately from the carrier element and arranged to limit the axial displacement of the actuating element in at least a first axial direction, the stop element arranged to be fastened to the carrier element or the housing via at least one fastening element.

2. The parking lock device according to claim 1, wherein the first fastening element also forms the fastening element of the stop element.

3. The parking lock device according to claim 1, wherein a stop force of the actuating element can be supported on the housing via the fastening element when it abuts against the stop element.

4. The parking lock device according to claim 1, wherein the stop element is designed as a stop plate.

5. The parking lock device according to claim 1, wherein the actuating element bears against the stop element to limit the axial movement in the first axial direction.

6. The parking lock device according to claim 1, wherein the stop element has at least one fastening region coupled to the fastening element and a stop region implementing the movement limitation of the actuating element and spaced apart from the fastening region.

7. The parking lock device according to claim 6, wherein the fastening region and the stop region are spaced apart from one another in the axial direction.

8. The parking lock device according to claim 1, wherein the actuating element has a conical actuating region which converts an axial movement of the actuating element into a pivoting movement of the locking pawl.

9. The parking lock device according to claim 1, wherein the locking pawl is received on the carrier element by a connecting element and is pivotable about the connecting element, wherein the connecting element has a longitudinal axis aligned to be parallel to the axial direction.

10. The parking lock device according to claim 1, wherein the actuating element is supported in the locked position on a support element which can be fastened to the housing via the first fastening element.

11. A parking lock device, comprising:
a first fastening element comprising a longitudinal axis defining an axial direction;
a carrier element arranged to be fastened to a housing by the first fastening element;
a locking pawl, pivotable on the carrier element between a locked position where the locking pawl is latched with a rotary component with a form fit, and a release position in which the locking pawl is decoupled from the rotary component;
an actuating element, axially displaceable between a first axial position where the actuating element deflects the locking pawl into the locked position, and a second axial position where the locking pawl is in the release position; and
a stop element, formed separately from the carrier element and arranged to limit axial displacement of the actuating element, the stop element arranged to be fastened to the carrier element or the housing by a second fastening element.

12. The parking lock device of claim 11, wherein the first fastening element also forms the second fastening element.

13. The parking lock device of claim 11, wherein the second fastening element is arranged to support a stop force of the actuating element on the housing when the actuating element abuts the stop element.

14. The parking lock device of claim 11, wherein the stop element is a stop plate.

15. The parking lock device of claim 11, wherein the actuating element bears against the stop element to limit axial displacement of the actuating element.

16. The parking lock device of claim 11, wherein the stop element comprises:
a fastening region coupled to the second fastening element; and
a stop region, spaced apart from the fastening region and arranged to limit axial displacement of the actuating element.

17. The parking lock device of claim 16, wherein the stop region is spaced apart from the fastening region in the axial direction.

18. The parking lock device of claim 11, wherein the actuating element comprises a conical actuating region arranged to pivot the locking pawl when the actuating element is axially displaced.

19. The parking lock device of claim 11, further comprising a connecting element connecting the locking pawl to the carrier element, wherein the locking pawl is pivotable about the connecting element.

20. The parking lock device of claim 11, further comprising a support element arranged to be fastened to the housing by the first fastening element, wherein the actuating element is supported in the locked position on the support element.
